(19) United States
(12) Patent Application Publication
(10) Pub. No.: US 2008/0002705 A1
(43) Pub. Date: Jan. 3, 2008

(54) Communication device, address learning method, and address learning program

(75) Inventor: Kazuto Nishimura, Kawasaki (JP)

Correspondence Address: BINGHAM MCCUTCHEN LLP, 2020 K Street, N.W., Intellectual Property Department, WASHINGTON, DC, 20006, US

(73) Assignee: Fujitsu Limited

(21) Appl. No.: 11/582,492

(22) Filed: Oct. 18, 2006

(30) Foreign Application Priority Data
Jun. 28, 2006 (JP) 2006-178475

(51) Int. Cl. H04L 12/56

(52) U.S. Cl. 370/392; 370/401

(57) ABSTRACT

A communication device configured to control destination of a received packet by implementing address learning, includes an address learning part configured to implement the address learning by using an IP address of the received packet. The communication device may further include a subnet information obtaining part configured to obtain subnet information; wherein the address learning part implements the address learning by using a host address in the IP address in a case where the subnet information can be obtained by the subnet information obtaining part.

### BACKGROUND OF THE INVENTION

1. Field of the Invention

The present invention generally relates to communication devices, address learning methods, and address learning programs, and more specifically, to a communication device configured to implement address learning, an address learning method, and an address learning program configured to make a computer implement the address learning method.

2. Description of the Related Art

A so-called bridge or L2 (Layer 2) switch has a function for relaying Ethernet (registered trademark) packets, implements address learning by using a MAC (Media Access Control) address existing in the Ethernet packet header, and implements packet forwarding based on learned information.

On the other hand, a router or L3 (Layer 3) switch generally builds an L2 domain (subnet) for every port. The routers exchange a routing protocol so as to build a routing table.

The above-mentioned L2 network (L2 domain) is normally a network of an extremely narrow area (domain) divided by the routers. The MAC (Media Access Control) address exists in order to uniquely identify each of hosts (PCs or routers) in this narrow L2 network. On this point, it is sufficient that uniqueness of the MAC address be kept in only the above-mentioned domain. However, actually, a globally unique value that is a value unique in the world is used as this MAC address. In order to realize this global uniqueness, the MAC address has an extremely long length of 48 bits.

Furthermore, the MAC address does not have a hierarchical structure indicating position information. The MAC address has a property as a simple individual identification ID. In other words, a MAC address whose number is different by one number from that of other MAC address may exist in an actually completely different physical place.

That is, since an address system does not exist in the MAC address, degeneracy (explained below) of the address cannot be implemented. Therefore, in address learning, it is necessary to store all of the MAC addresses as individual entries.

As a result of this, the address learning table required for address learning has great width and depth.

Here, “address learning” means storing a source address held by a received packet and a port receiving the packet that are associated with each other as an entry of the address learning table. If a packet having the address as a destination address is received as a result of the address learning, the packet is sent to an associated port at a corresponding entry so as to be sent to the destination.

FIG. 1 is a view for explaining a related art address learning operation. For example, as shown in FIG. 1, a subnet whose IP address is “10.1.1.0/24” is assumed. In FIG. 1, there are bridges 1 through 34 in the subnet and the bridges 1 through 34 are connected to an external network via a GW (Gateway) router. Examples of the address learning tables held by the bridges are indicated at the right side in FIG. 1.

As shown in FIG. 1, each of the entries of the address learning table applied to address learning using the MAC address has a MAC address (48 bits) and corresponding port.

In this case, regardless of the topology of a LAN (Local Area Network) forming the subnet, it is necessary for each of the bridges to implement address learning wherein 1 MAC address is counted as 1 entry. As a result of this, the number of entries of each of the bridges is 254 as maximum. See Japanese Laid-Open Patent Application Publication No. 10-336228.

### SUMMARY OF THE INVENTION

Accordingly, the present invention may provide a novel and useful modular communication device, address learning method, and address learning program solving one or more of the problems discussed above.

More specifically, the embodiments of the present invention may provide a communication device such as a bridge whereby the amount of information required for address learning is effectively reduced, an address learning method, and an address learning program.

One aspect of the present invention may be to provide a communication device configured to control destination of a received packet by implementing address learning, includes an address learning part configured to implement the address learning by using an IP address of the received packet.

Other aspect of the present invention may be to provide an address learning method applied to a communication device configured to control a destination of a received packet by implementing address learning, the address learning method including a step of implementing the address learning by using an IP address of the received packet.

Other aspect of the present invention may be to provide an address learning program for making the computer implement address learning in a communication device configured to control a destination of a received packet by implementing the address learning, the address learning program including a command for making the computer implement a step for implementing the address learning by using an IP address of the received packet.

The bit length of the IP address is 32 bits and therefore extremely shorter than the MAC address of 48 bits. Hence, width of the address learning table required for the address learning can be extremely reduced.

In addition, the IP address, unlike the MAC address, is a systematic address and therefore degeneracy of the address can be implemented. As a result of this, the depth (namely, the number of entries) of the address learning table can be effectively reduced.

Since the width and depth of the address learning table can be reduced, it is possible to effectively reduce the amount of information required for the address learning table and a necessary capacity of a storage device which stores the amount of the information. As a result of this, it is possible to miniaturize the communication device, achieve low cost of the communication device, improve working speed, etc.

Other objects, features, and advantages of the present invention will be come more apparent from the following detailed description when read in conjunction with the accompanying drawings.

### BRIEF DESCRIPTION OF THE DRAWINGS

FIG. 1 is a view for explaining a related art address learning operation;

FIG. 2 is a table for explaining an example of a packet format in a case where an IP packet is encapsulated by the Ethernet packet;

FIG. 3 is a block diagram of a communication device of a first embodiment of the present invention;

FIG. 4 is a view showing an example of contents of an IP address table (address learning table) that can be applied to the communication device shown in FIG. 3;

FIG. 5 is a block diagram of a communication device of a second embodiment of the present invention;

FIG. 6 is a view showing an example of contents of an IP address table that can be applied to a communication device of a third embodiment of the present invention;

FIG. 7 is a block diagram of a communication device of a fourth embodiment of the present invention;

FIG. 8 is a block diagram of a communication device of a fifth embodiment of the present invention;

FIG. 9 is a block diagram of a communication device of a sixth embodiment of the present invention;

FIG. 10 is a block diagram of a communication device of a seventh embodiment of the present invention;

FIG. 11 is a view explaining degeneracy of the IP address;

FIG. 12 is a view for explaining effects of the embodiments of the present invention;

FIG. 13 is a flowchart for explaining an address learning operation of the embodiments of the present invention;

FIG. 14 is a flowchart for explaining a forwarding operation of the embodiments of the present invention;

FIG. 15 is a first schematic example for concretely explaining the operations shown in FIG. 13 and FIG. 14;

FIG. 16 is a second schematic example for concretely explaining the operations shown in FIG. 13 and FIG. 14;

FIG. 17 is a third schematic example for concretely explaining the operations shown in FIG. 13 and FIG. 14;

FIG. 18 is a fourth schematic example for concretely explaining the operations shown in FIG. 13 and FIG. 14;

FIG. 19 is a fifth schematic example for concretely explaining the operations shown in FIG. 13 and FIG. 14;

FIG. 20 is a sixth schematic example for concretely explaining the operations shown in FIG. 13 and FIG. 14;

FIG. 21 is a seventh schematic example for concretely explaining the operations shown in FIG. 13 and FIG. 14;

FIG. 22 is an eighth schematic example for concretely explaining the operations shown in FIG. 13 and FIG. 14;

FIG. 23 is a ninth schematic example for concretely explaining the operations shown in FIG. 13 and FIG. 14; and

FIG. 24 is a computer block diagram for explaining an example where the embodiments of the present invention are realized by a computer.

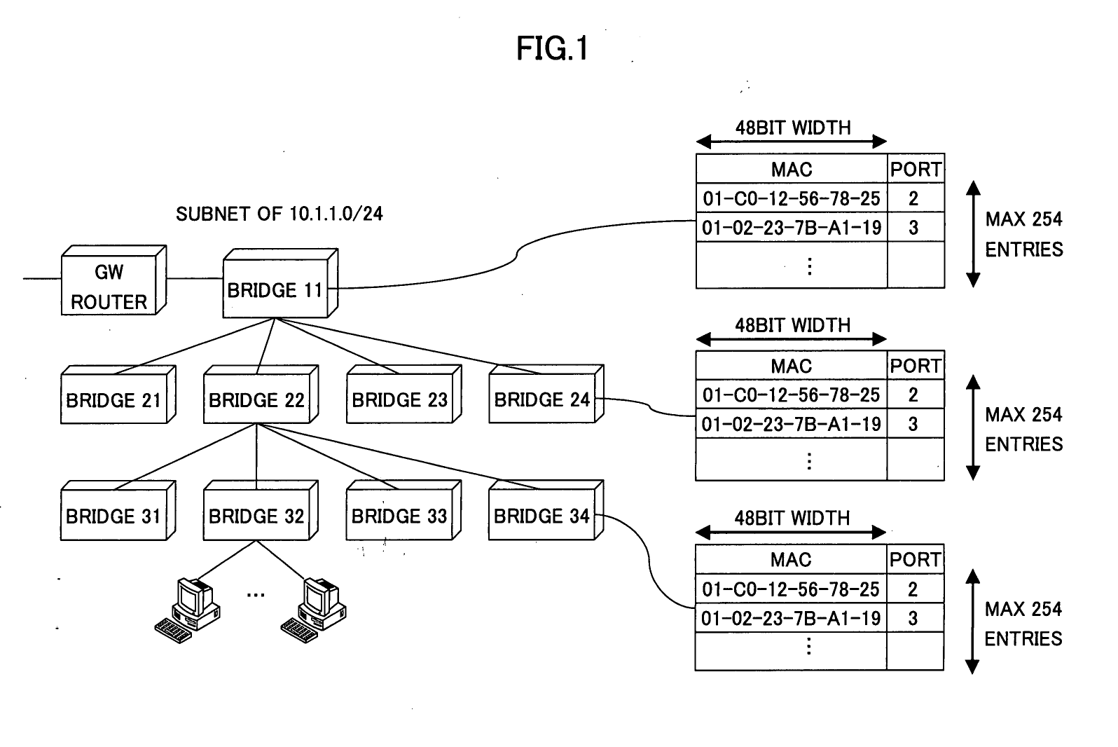

### DETAILED DESCRIPTION OF THE PREFERRED EMBODIMENTS

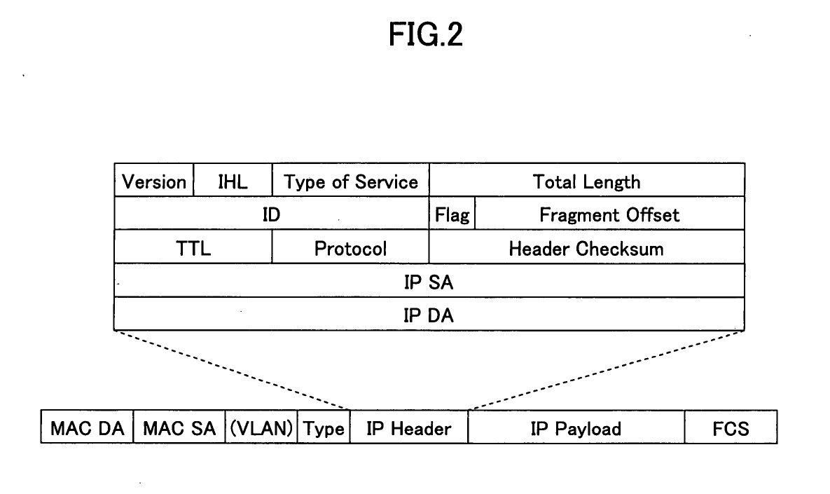

A description is given below, with reference to the FIG. 2 through FIG. 24, of embodiments of the present invention.

The embodiments of the present invention provides a communication device configured to control destination of a received packet by implementing address learning, including an address learning part configured to implement the address learning by using an IP address of the received packet.

According to the above-mentioned communication device, it is possible to reduce the address width of the subject of address learning in the bridge, namely the width of the address learning table, to the length of an IP address, namely 32 bits.

The communication device may further include a subnet information obtaining part configured to obtain subnet information; wherein the address learning part implements the address learning by using a host address in the IP address in a case where the subnet information can be obtained by the subnet information obtaining part.

According to the above-mentioned communication device, under the environment where the host address can be determined, the address width of the subject of the address learning can be further made smaller.

In the communication device, the address learning part implements the address learning by using VLAN information.

According to the above-mentioned communication device, even in an IVL mode discussed below, it is possible to apply address learning using the IP address.

The communication device may further include an IP address learning suitability determining part configured to determine suitability of implement of the address learning by using the IP address; wherein the address learning part does not implement address learning using a MAC address of the received packet in a case where the IP address learning suitability determining part determines that the address learning using the IP address is unsuitable.

According to the above-mentioned communication device, in a case where connection to an outside network via the gateway router is made, it is possible to prevent outside unnecessary address from being stored in the address learning table.

In the communication device, in the case where the IP address learning suitability determining part determines that the address learning using the IP address is unsuitable, the address learning part implements the address learning by using a MAC address of the received packet.

According to the above-mentioned communication device, it is possible to determine the MAC address of the gateway router and therefore it is possible to securely and properly implement the packet processing outside of the domain.

The communication device may further include a subnet information obtaining part configured to obtain subnet information; wherein the IP address learning suitability determining part determines that address learning using an IP address not belonging to a subnet obtained by the subnet information is unsuitable in a case where the subnet information obtaining part can be obtained by the subnet information obtaining part.

According to the above-mentioned communication device, under conditions that the subnet can be determined, it is possible to securely determine an address as unsuitable for the subject of the address learning.

The communication device may further include a subnet estimating part configured to estimate a subnet based on result of address learning using the IP address by the address learning part; wherein the IP address learning suitability determining part determines that the address learning using an IP address not belonging to the subnet estimated by the subnet estimating part is unsuitable.

According to the above-mentioned communication device, even if the subnet is not clearly determined, it is possible to determine whether an address is proper for the address learning without using logic such as MAC address identification.

In the communication device, the IP address learning suitability determining part may compare the MAC addresses and the IP addresses between the received packets, and may determine that the IP address of one of the received packets is unsuitable as for the address learning if the one of the received packets has the same sender MAC address and a different sender IP address.

According to the above-mentioned communication device, while the logic for MAC address identification is necessary, even if the subnet is not clearly determined, it is possible to determine whether an address is proper for the address learning.

In the communication device, in the case where the IP address learning suitability determining part determines that the address learning using the IP address is unsuitable, a port where a corresponding received packet arrives is set to be a default port, and a packet forwarding part sends a received packet having an IP address as a destination IP address, which IP address is determined to be unsuitable for the address learning, to the default port.

According to the above-mentioned communication device, the packet determined to be sent outside of the domain is sent to only the default port even if the packet is not learned. Hence, it is possible to prevent excessive flooding so that a communication band can be efficiently used.

In addition, if the degeneracy of the address can be performed in the address learning using the continuous IP addresses, the IP address of the address learning can be degenerated to the corresponding address group.

As a result of this, it is possible to effectively reduce the number of entries of the address learning table.

In the above-mentioned degeneracy of the address, the learned IP address is degenerated only when all of the IP addresses included in the address group are learned at the same port.

As a result of this, it is possible to securely degenerate the address without influence of the status of learning at other ports.

In the above-mentioned degeneracy of the address, even if all of the IP addresses included in the address group are not learned at the same port, when a constant condition is satisfied, the already learned IP address value can be degenerated to the address group.

In this case, while a process for degenerating or breaking degeneracy is necessary depending on the status of learning at other ports and use of an effect of the doctrine of longest match is necessary, it is possible to achieve an effective address degeneracy effect.

In the communication device, the address learning part does not implement the address leaning in a case where the received packet does not have an IP address.

According to the above-mentioned communication device, in a case where the network is basically an IP network and a small number of non-IP packets such as ARP are sent, it is possible to prevent useless address learning and efficiently use the address learning table.

In the communication device, the address learning part implements the address learning by using a MAC address held by the received packet in a case where the received packet does not have an IP address.

In this case, while address learning for unnecessary MAC addresses by using a control packet such as the ARP packet may be necessary, it is possible to flexibly correspond regardless of whether the network is an IP network or non-IP network.

As discussed above, the conventional bridge normally implements address learning of the MAC address. However, as discussed above, in the address learning by the MAC address, it is not possible to reduce the size of the address learning table.

Accordingly, in the embodiments of the present invention, instead of the address learning using the MAC address, address learning using the IP address is implemented. As a result of this, it is possible to reduce the size of the necessary address learning table.

A “layer” in the field of communication is defined independently from other layers. Hence, the address learning using the MAC address has been implemented. However, in the present network situation, a network applying the IP address to layer 3 above layer 2 is frequently used. According to the embodiments of the present invention, the size of the address learning table is drastically reduced by applying closer connection between the layers.

In other words, as discussed above, in the communication device such as the bridge, instead of the address learning using the MAC address, the address learning using the IP address is implemented.

Meanwhile, FIG. 2 is a table for explaining an example of a packet format in a case where an IP packet is encapsulated by an Ethernet packet.

As shown in FIG. 2, the IP packet includes MAC DA, MAC SA (MACe Source Address), (VLAN), and an IP Header. The IP Header includes IP SA (IP Source Address) and IP DA (IP. Destination Address) While address learning using the above-mentioned MAC SA is implemented in the related art bridge, address learning using the above-mentioned IP SA is implemented in the embodiment of the present invention.

In addition, while the forwarding operation is implemented with reference to the above-mentioned MAC DA in the related art, forwarding of a packet is implemented with reference to IP DA instead of the MAC DA in the embodiment of the present invention.

Because of this, it is required that the same function as that obtained by the related art MAC address (MAC SA, MAC DA) can be obtained by the IP address (IP SA, IP DA). The function provided by the related art MAC address includes a uniqueness securing function in the domain name.

The IP address can be divided into a network address part and a host address part. In the IP addresses of the host in the L2 domain, the network address parts are the same, while the host address parts are different. By using this characteristic, it is possible to secure uniqueness in-the domain even in a case of the address learning by the IP address.

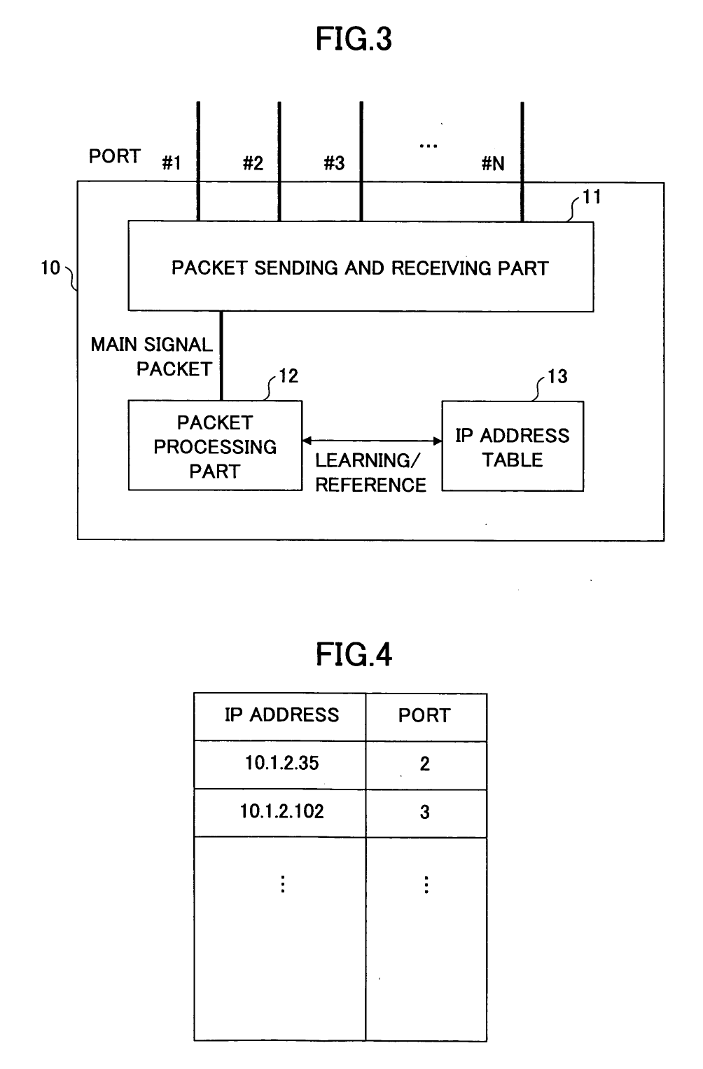

FIG. 3 is a block diagram of a communication device of a first embodiment of the present invention. FIG. 4 is a view showing an example of contents of an IP address table (address learning table) that can be applied to the communication device shown in FIG. 3.

Basically, operations with respect to address learning and forwarding of the packet are the same as those of the related art bridge. However, as discussed above, the embodiment of the present invention is different from the related art in that the address learning uses the IP address instead of the MAC address and the packet forwarding operation is implemented by the IP address. Accordingly, in the following, explanation of structures and functions that are the same as those of the related art bridge is omitted.

If the packet arrives at a designated port of a bridge 10, the packet is sent to a packet processing part 12 via a packet sending and receiving part 11. In the packet processing part 12, first, an IP address 13 is searched for by using the IP SA shown in FIG. 2, as a key, included in the IP Header of the packet. In this case, if there is no consistent entry, the IP SA, together with information of the port where the packet has arrived, is added in the entry of the IP address table.

Next, the IP address table 13 is searched by using the IP DA in the IP Header as a key. If there is a consistent entry, the packet is sent to only the corresponding port. If there is no consistent entry, flooding is performed for the packet.

Furthermore, as discussed above, since the uniqueness of the address in the L2 domain can be secured by only the host address, if the host address of the packet can be determined, the address learning may be implemented by using only the host address.

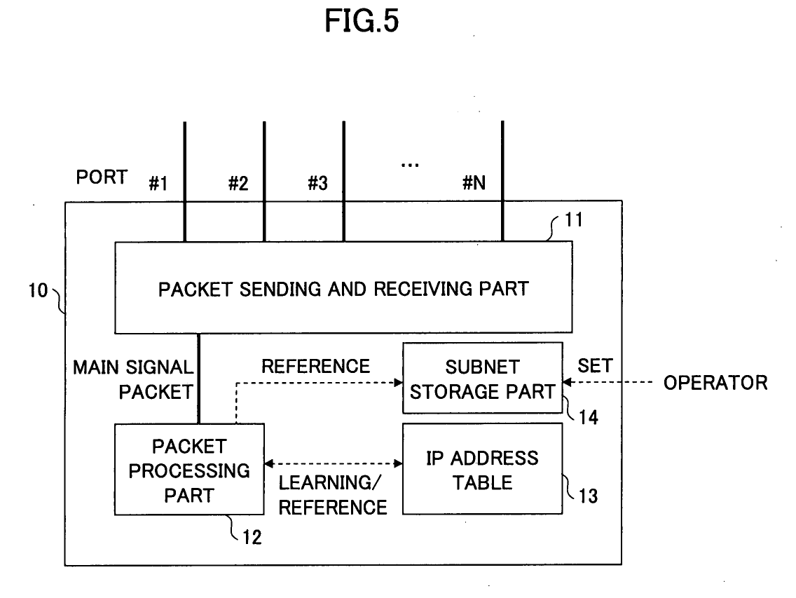

The host address is determined, for example, when an operator of the bridge 10 sets subnet information in the bridge 10. A device block structure in this example (the second embodiment of the present invention) is shown in FIG. 5. Here, FIG. 5 is a block diagram of a communication device of a second embodiment of the present invention.

In this case, a subnet storage part 14 that is a functional block is newly added to the bridge 10. A subnet value set by the operator is held in this block.

In this embodiment, when the packet arrives, its IP header is referred to by the packet processing part 12 and, furthermore, the subnet value that is set in the subnet storage part 14 is referred to. As a result of this, the subnet value of the IP address included in the IP header of the packet is confirmed. A part other than the subnet value, namely only the host address part, is added, if necessary, as entry of the IP address table 13.

In the meantime, in the conventional address learning by the MAC address, two methods, namely an SVL (Shared VLAN Learning) method and an IVL (Independent VLAN Learning) method, are used. Here, while in the SVL method only the MAC address is learned, in the IVL method the VLAN ID in addition to the MAC address is used so that the address learning is implemented.

The way of thinking of the IVL method can be applied to the embodiment of the present invention. In this case (the third embodiment of the present invention), since the IVL method is applied, both the IP address and the VLAN ID (VLAN information) are used so that the address learning is implemented.

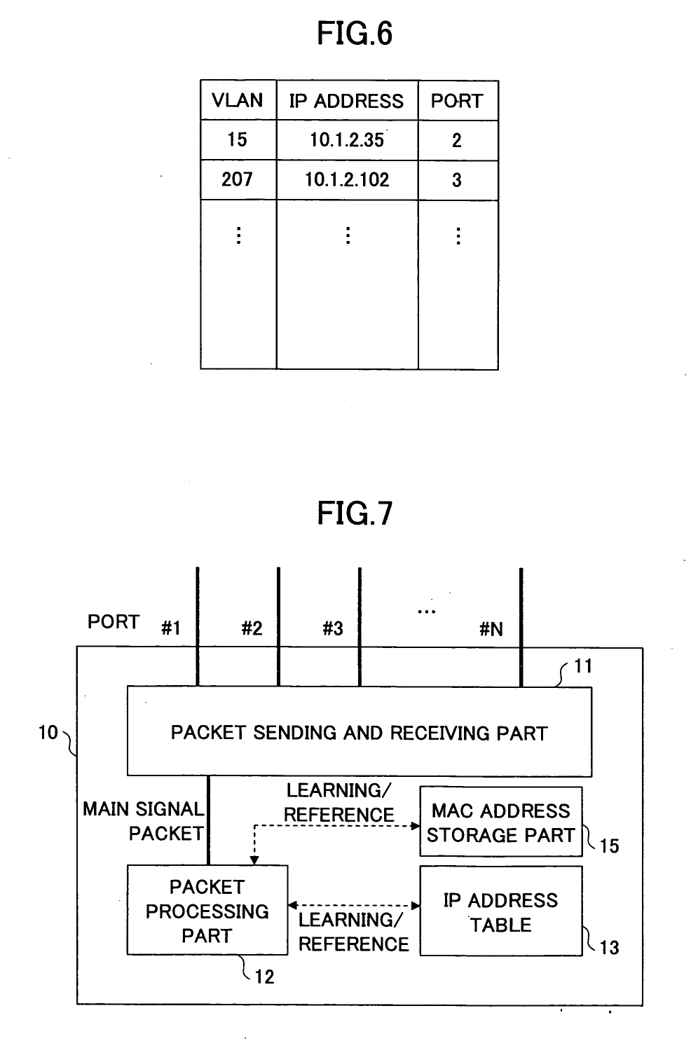

FIG. 6 is a view showing an example of contents of an IP address table that can be applied to a communication device of a third embodiment of the present invention.

In a case where the address learning is implemented by the IP address as discussed above, a problem may occur that is not generated in the conventional address learning by the MAC address.

In other words, when the bridge is connected to an outside network (hereinafter “gateway router outside”) via a GW (gateway) router, an IP address of the gateway router outside may be appropriate for the address learning. Because of this, all of the IP addresses existing in the Internet may be learned as a-result. In this case, the necessary size of the address learning table may be drastically increased.

It is preferable to take the following measures in the embodiment of the present invention in order to prevent the above-discussed problem. In other words, in a case where it is determined that the IP address held by the IP header of the received packet is the gateway router outside and should not be learned, a structure whereby the IP address is excluded from being learned is provided.

In this case, a structure where the address learning is not implemented at all may be applied. However, the present invention is not limited to this. In other words, if it is determined that the IP address held by the IP header of the received packet is the gateway router outside, the MAC address in the packet may be learned.

FIG. 7 is a block diagram of a communication device of such an example (a fourth embodiment of the present invention). In the fourth embodiment of the present invention, the MAC address of the gateway router outside is the subject of learning. Because of this, the MAC address storage part 15 is provided in the fourth embodiment of the present invention. If the MAC address of the gateway router outside is learned, the MAC address is stored in the MAC address storage part 15. In this case, after this, the packet processing part 12 of the bridge 10 controls so that the IP SA of the packet having the MAC address as the MAC SA is not the subject of learning. In addition, the IP DA of the packet having the MAC address as the MAC DA is not confirmed and the packet is forwarded to the gateway router port.

In the fourth embodiment of the present invention, a structure for determining if the IP address is the gate way router outside is required. For example, if the subnet where the bridge belongs can be specifically determined, it may be determined that the packet having the network address other than the subnet is a packet from the gateway router outside.

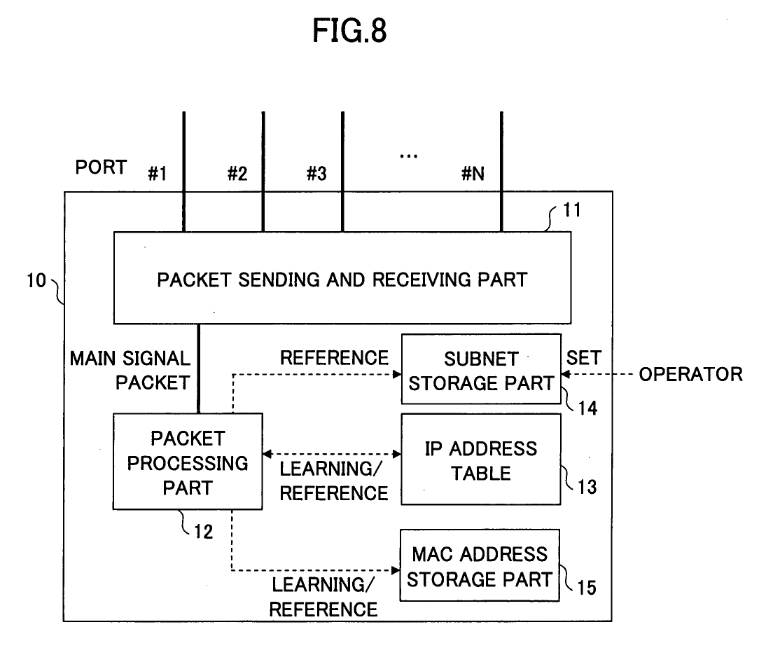

Thus, the operator of the bridge 10 can set the subnet information in the bridge 10 as a fifth embodiment where the subnet can be determined. FIG. 8 is a block diagram of a communication device of the fifth embodiment of the present invention.

In this embodiment, as shown in FIG. 8, a subnet storage part 14 configured to store subnet information is provided. In the packet processing part 12, the IP header of the received packet is referred to and the subnet value set in the subnet storage part 14 is referred to. If the packet has a subnet value other than the subnet value referred here, the packet is determined to be from the gateway router outside. In this case, as discussed above, the MAC address is stored in the MAC address storage part 15. The MAC address stored in the MAC address storage part 15 is used so that whether the received packet is a packet from the gateway router outside is determined.

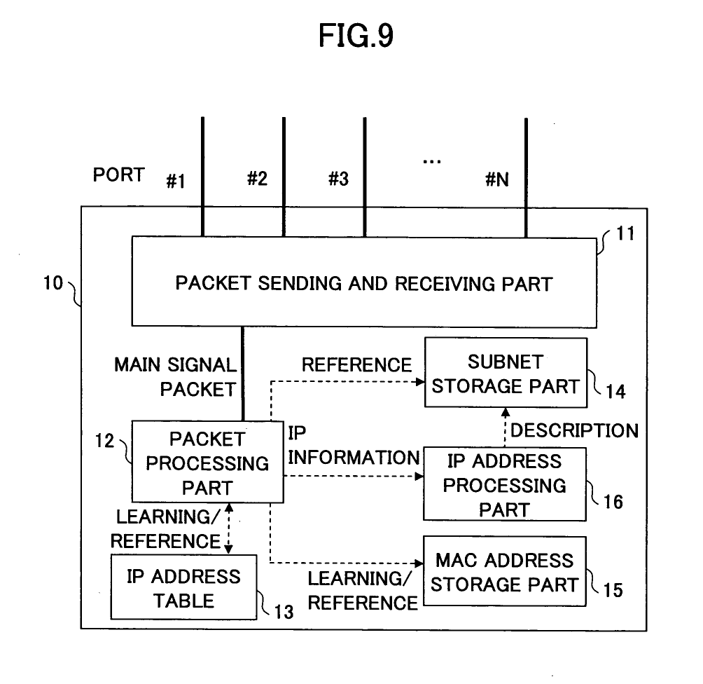

In addition, in the case where the subnet information is not directly obtained, for example, a method can be applied wherein a network address is assumed based on the packet arriving from plural ports. FIG. 9 is a block diagram of a communication device of a sixth embodiment of the present invention wherein the above-mentioned method is applied.

In the sixth embodiment of the present invention, an IP address processing part 16 is provided. The IP address processing part 16 stores IP address information arriving at the ports of the bridge 10 and estimates the subnet value of the subnet where the bridge 10 belongs from the obtained the IP address information.

For example, it is assumed that a packet having an IP address of “10.1.1.3” arrives from the port 1, a packet having an IP address of “10.1.1.89” arrives from the port 2, and a packet having an IP address of “10.1.1.46” arrives from the port 3. In this case, from these IP addresses, it is estimated that the subnet value of the subnet where the bridge belongs is close to “10.1.1.0/24” or “10.1.1.0/25” (the meaning of “/” is discussed below). The IP address processing part 16 stores the estimated value in the subnet storage part 14.

Next, when a packet having an IP address of “56.3.7.28” arrives from the port 4, this IP address is clearly different from the above-mentioned estimated subnet value of “10.1.1.0/24” or “10.1.1.0/25”. Accordingly, the packet processing part 12 determines that the received packet is a packet from the gateway router outside.

As an alternative, a method using a general characteristic of the gateway router may be applied. In other words, in the packet received via the gateway router, the value of the IP SA is held as it is. On the other hand, the MAC SA is replaced with the value of the MAC address of the gateway router per se by an end process of L2. Accordingly, in a packet group arriving via the gateway router, while the IP addresses are different from each other, the MAC addresses are consistent, namely they contain the value of the gateway router.

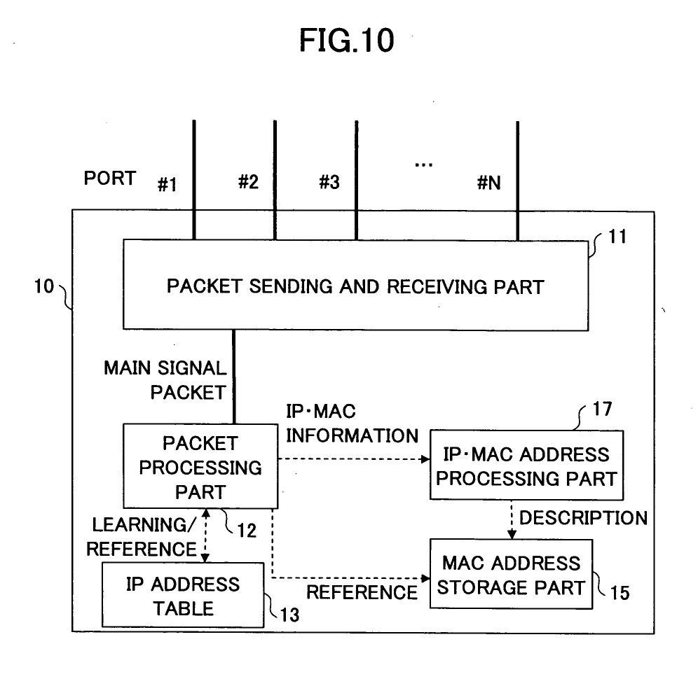

FIG. 10 is a block diagram of a communication device of a seventh embodiment of the present invention for a function for determining a packet from the gateway router outside by using such a characteristic.

In the seventh embodiment, the IP.MAC address processing part 17 is provided. In the IP MAC address processing part 17, when the packet arrives, both the MAC SA and the IP SA are stored for a while in a designated temporary storage area (not shown). When a new packet arrives, the MAC SA and the IP SA of the new packet are compared to the MAC SA and IP SA stored for a while in the designated temporary storage area. If the comparison result indicates “While the MAC SA are consistent, the IP SAs are different”, the packet is determined to be a packet of the gateway router outside.

In this embodiment, if the MAC SA of all of the packets are stored, the necessary memory capacity is drastically increased. In order to prevent this, it is preferable that the subnet estimating function of the sixth embodiment of the present invention be combined with this seventh embodiment so that MAC SA and IP SA of only the packet having a doubtful IP SA is stored for a while in the temporary storage area.

By either of the structures of these embodiments, the packet from the gateway router outside can be determined. In addition, a port receiving the packet from the gateway router outside may be set in a default port. This is substantially the same as the way of thinking of a default port of the conventional gateway router. The packet wherein the IP DA belongs to the gateway router outside is sent to only the default port.

In the above explanation, the embodiments mainly with respect to reduction in the width direction of the address learning table 13 are discussed. Since, as discussed above, the IP address is a systematic address, it is possible to decrease the number of entries in the address learning table 13 by degenerating the addresses.

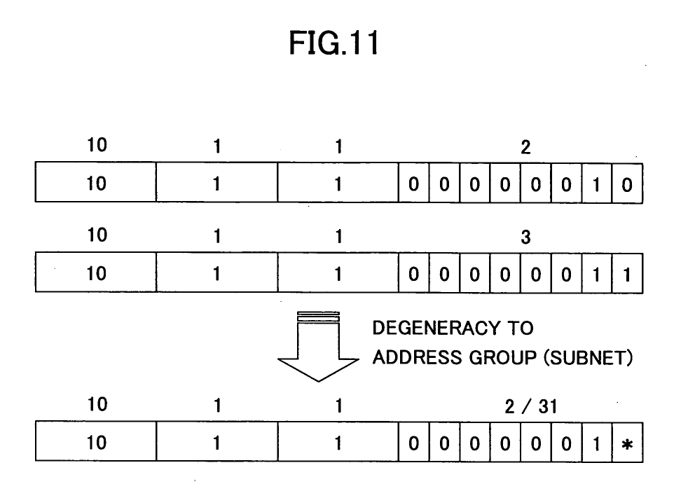

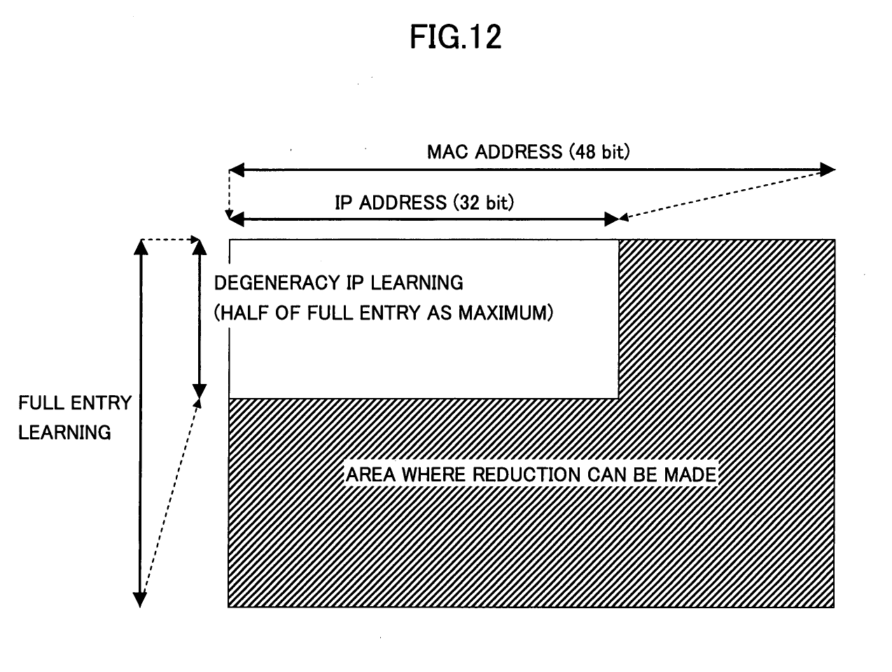

FIG. 11 is a view explaining degeneracy of the IP address. For example, as shown in FIG. 11, it is assumed that two packets having two IP addresses, “10.1.1.2” and “10.1.1.3” are received at the same port. In this case, at two entries of the address learning table 13, the IP addresses are stored for the same port. In other words, these plural IP addresses are learned at the same ports. In FIG. 11, the address is expressed in binary form.

In these two addresses, all bits except the lower 1 bit are consistent. Therefore, degeneracy to an address group of “10.1.1.2/31” wherein the lower 1 bit is optional can be performed. As a result of this, since the corresponding entry is single, it is possible to reduce the depth (namely the number of entries) of the address learning table 13. See FIG. 12. Here, FIG. 12 is a view for explaining effects of the embodiments of the present invention. “/31” of “10.1.1.2/31” means the 31^{st} digit. In other words, “2/31” means that the 31^{st} digit (second from lowest) is “2 (“10” in binary)”.

In a case where all of the IP addresses included in the address group are learned at the same port, that is, in a case where plural packets all having corresponding IP addresses are received at the same port, the IP addresses can be degenerated into the address group. In other words, a complete coverage indication indicating the address group is stored at a single entry of the port.

More specifically, for example, if a group of IP addresses, “10.1.1.1” through “10.1.1.7”, arrive from the port 1, these addresses are degenerated to “10.1.1.0/29”. “10.1.1.0/29” is a complete coverage indication comprehensively indicating all of addresses wherein the 1^{st} through 28^{th} digits are “10.1.1”, the 29^{th} digit is “0”, and the 30^{th} through 32^{nd} digits are optional.

In other words, if binary numerals of the address group of “10.1.1.1” through “10.1.1.7” are included, the last eight digits “1” through “7” are expressed as “00000001” through “00000111”. In these addresses, the 29^{th} digit, namely the fourth from last digit is, is “0”. Therefore, in this case, a complete coverage indication indicating the IP addresses wherein the 1^{st} through 28^{th} digits are “10.1.1” and the 29^{th} digit is “0” can be made.

In this case, in the entry of the corresponding address learning table 13, the IP address is “10.1.1.0/29” and the port is 1. Control is performed so that all of the packets where the corresponding IP addresses are provided in the IP DA are sent to the port 1.

In this case, 7 entries, namely “10.1.1.1” through “10.1.1.7”, can be made to be a single entry. This process is called “degeneracy of address”.

Furthermore, even if all information is not learned at the same port, as long as a constant condition is satisfied, degeneracy of the addresses to corresponding address group can be implemented. An example of this way is discussed below.

It is assumed that, for example, packets having the IP addresses “10.1.1.1” through “10.1.1.3” and “10.1.1.5” through “10.1.1.7” are received at the port 1 and address learning is implemented based on the corresponding contents. It is also assumed that, for example, a packet having the IP address “10.1.1.4” is received at the port 2 and address learning is implemented based on the corresponding contents.

In this case, for the address learning table 13, the entry at the port 1 is degenerated to “10.1.1.0/29”. As discussed above, the address “10.1.1.4” learned at the port 2 is included in the address “10.1.0/29” of the complete coverage indication with respect to degeneracy of the addresses at the port 1, that is, the address group “10.1.1.1” through “10.1.1.7”.

In this case as well as the case of the conventional IP routing table, a doctrine of “longest match” may be applied. As a result of this, the packet with the address “10.1.1.4” is controlled to be sent to the port 2. Therefore, it is possible to implement degeneracy of the address. However, in this method, if the entry of “10.1.1.4” is deleted, it is necessary to break the degeneracy of the address group at the port 1. In other words, one entry of the complete coverage indication should be returned to the entries having individual addresses except “10.1.1.4”.

Thus, in the doctrine of “longest match”, a longest match entry is applied to routing (forwarding). Since the individual indication can obtain longer match (namely larger bit numbers) than the complete coverage indication, the entry of the individual indication is applied with priority.

Although the above-mentioned example is based on assumption that the received packet has an IP address, the received packet may not have an IP address. For example, a control packet such as ARP (Address Resolution Protocol) or a non-IP network such as Apple Talk corresponds to this.

As an operation in a case where these packets are received, control for not implementing any address learning of the packet may be made.

Alternatively, a method may be applied wherein conventional address learning using the MAC address may be implemented if these packets are received. This method can be applied for the IP network or non-IP network.

Next, details of structures of embodiments of the present invention are discussed.

The embodiments of the present invention include a structure where address learning using the IP address is implemented, a structure where address learning using the MAC address is implemented if the address learning using the IP address is determined to be improper, a structure where address learning is determined to be improper if a packet wherein a sender MAC address is the same but a sender IP address is different is determined to be a gateway router outside packet so that the IP address is used, a structure where degeneracy of the address is implemented, and a structure where degeneracy of address is implemented when all of them are not learned at the same port but a constant condition is satisfied.

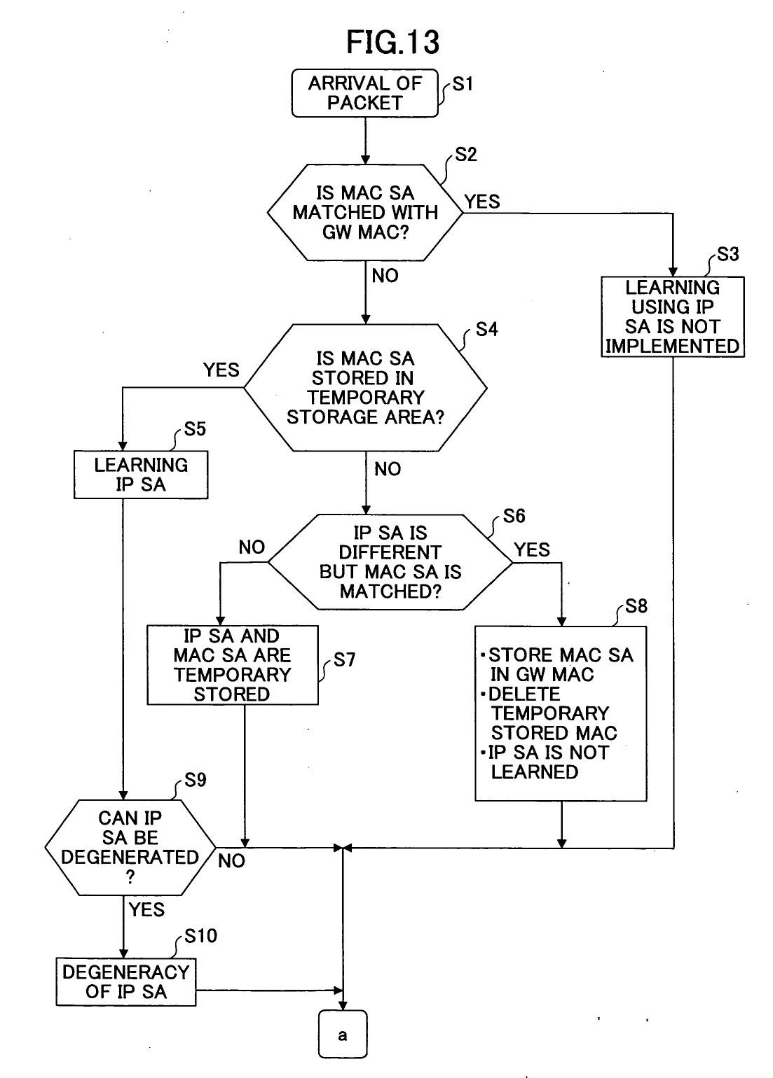

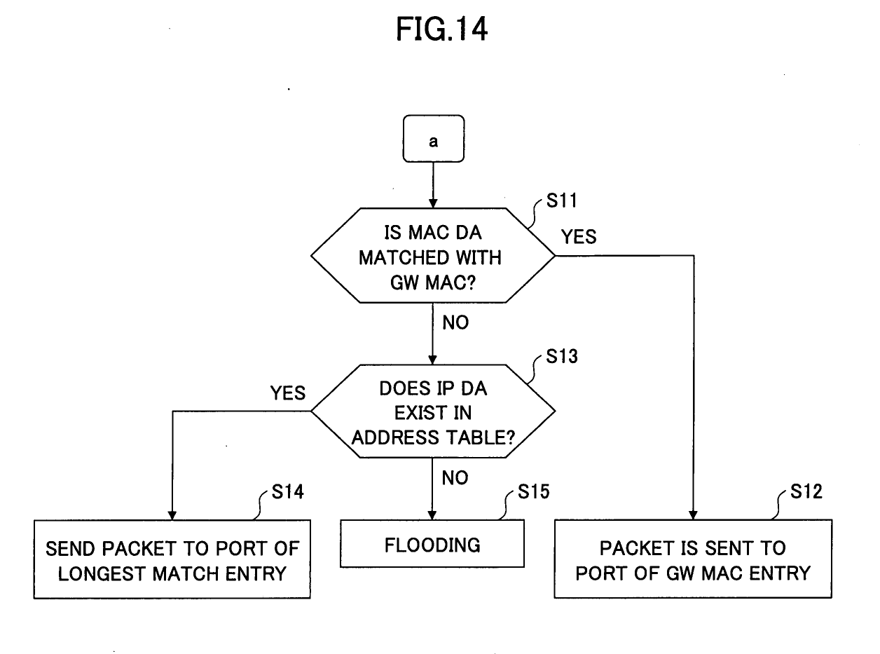

FIG. 13 is a flowchart for explaining an address learning operation of the embodiments of the present invention. FIG. 14 is a flowchart for explaining a forwarding operation of the embodiments of the present invention.

Referring to FIG. 13, if the packet arrives at the bridge 10 in step Si, whether MAC SA is matched with an entry in a gateway router MAC address table in the MAC address storage part shown in FIG. 10 is determined in step S2. If the MAC SA is matched with the entry in the gateway router MAC address table, it is determined that the packet comes from the gateway router so that address learning using the IP SA is not implemented in step S3.

If the MAC SA is not matched with the entry in the gateway router MAC address table, whether the MAC SA is stored in the temporary storage area for a while is determined in step S4. In other words, in order to realize a structure of “a packet wherein a sender MAC address is the same but a sender IP address is different is determined to be a gateway router outside packet”, it is necessary to compare MAC SA of the packets. Because of this, as discussed above, the IP SA and MAC SA of the packet arriving from the gateway router should be stored for a while in the temporary storage area.

As a method for determining if the packet comes via the gateway router, a method may be applied wherein a packet having an IP address clearly different from an IP address group learned at plural ports, namely an IP address group stored as an entry in the address learning table 13 of plural ports is doubted. For a detailed standard of “clearly different”, a method may be applied wherein, as for the IP SA of the packet, a part (upper 16b bits) corresponding to a work address of a class B network is compared to the learned IP address group.

If the IP SA of the received packet is matched with the IP SA already learned at plural ports, it is determined that the packet is not received via the gateway router (YES in step S4). In this case, the IP SA is a subject of address learning (is learned) in step S5. If the IP SA of the received packet is not matched with the IP SA already learned at plural ports (NO in step S4), the IP SA and MAC SA already stored for a while in the temporary storage area are compared to the IP SA and the MAC SA of the packet in step S6.

If the IP SA is different but the MAC SA is matched (YES in step S6), the packet is regarded as a packet via the gateway router so that in-step S8 the MAC SA is stored in the gateway router MAC address table of the MAC address storage part 15 shown in FIG. 10. In addition, the IP address and the MAC address temporarily stored are deleted from the temporary stored area in step S8. Furthermore, in this case, the IP SA of the arrived packet is not stored in step S8.

In a case other than this, namely a case where the comparison result in step S6 is not “the IP SA is different but the MAC SA is matched”, the IP SA and the MAC SA of the packet are stored in the temporary stored area in step S7.

In a case where the IP SA is learned in step S5, if the address can be degenerated by learning the IP SA, degeneracy of the address can be performed in steps S9 and S10.

When the address learning operation shown in FIG. 13 is completed, operation at the bridge moves to the forwarding operation shown in FIG. 14. In this case, first, whether the MAC DA of the packet is matched with the entry of the gateway router MAC address table is determined in step S11. If the MAC DA of the packet is matched with the entry of the gateway router MAC address table (YES in step S11), the packet is sent to the port of the entry of the gateway router MAC address table in step S12 so that the packet is sent to the gateway router.

If the MAC DA of the packet is not matched with the entry of the gateway router MAC address table (NO in step S11), whether the IP DA of the packer exists in the address learning table 13 is determined in step S13. If the IP DA of the packet exists in the address learning table 13, the packet is sent to the port of the entry where the IP address is longest matched in step S14. If the IP DA of the packer does not exist in the address learning table 13, flooding of the packet is performed via all ports other than the arrival port in step S15.

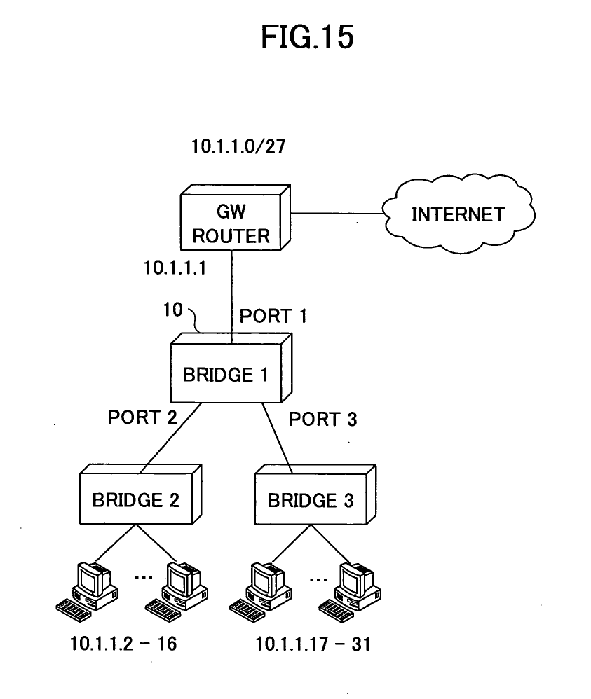

FIG. 15 through FIG. 23 are first through ninth schematic examples for concretely explaining the operations shown in FIG. 13 and FIG. 14.

First, by using a network structure shown in FIG. 15 as an example, address learning operations at the bridge 10 (bridge 1) of the embodiments of the present invention are discussed.

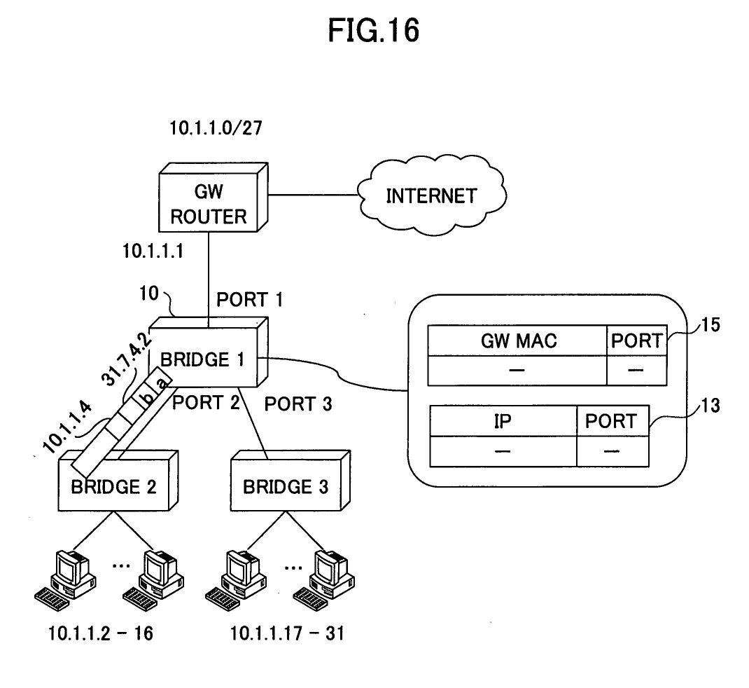

At a primary state, as shown in FIG. 16, a packet arrives from the port 2 of the bridge 1 at the bridge 2 neighboring in the same domain as in step S1 of FIG. 13. The packet has “MAC DA=a, MAC SA=b, IP DA=31.7.4.2, IP SA=10.1.1.4”.

In this case, since this is the first packet, there is no match with the gateway router MAC address in the address learning operation (NO in step S2 of FIG. 13). Since there is no learned IP address group, step S4 in FIG. 13 is determined as YES. Therefore, the IP SA is learned in step S5. In addition, since this is the first entry of the address learning table 13, the degeneracy of the address is not implemented (NO in step S9 of FIG. 13).

Next, in the packet forwarding operation shown in FIG. 14, because of the primary state, there is no entry of the gateway router MAC address (NO in step S11 of FIG. 14). In addition, there is no entry in the IP address table (NO in step S13 of FIG. 14). Hence, flooding (step 15 of FIG. 14) of the packet is implemented.

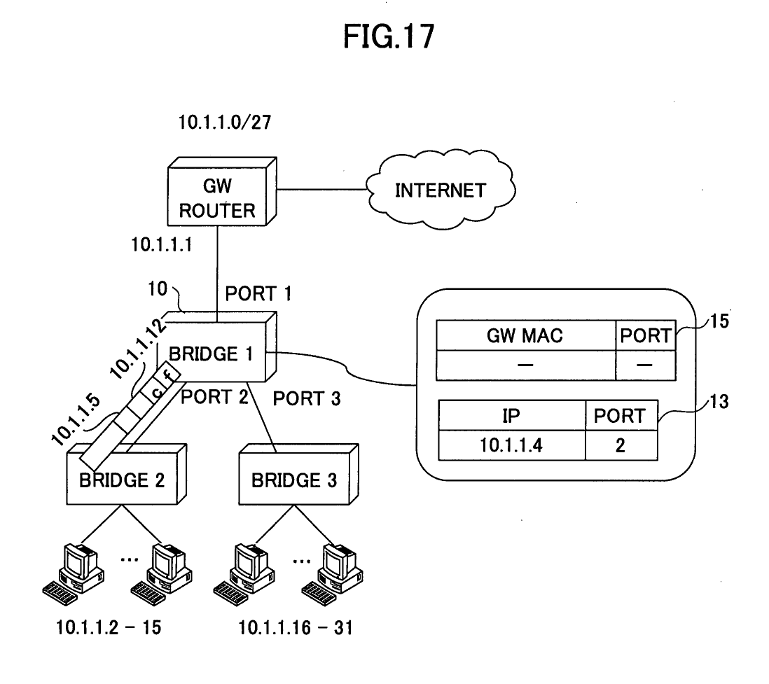

Next, as shown in FIG. 17, if new packet having IP SA “10.1.1.5” arrives from the bridge 2 to the bridge 1, IP SA is learned and flooding is performed in step S15 of FIG. 14.

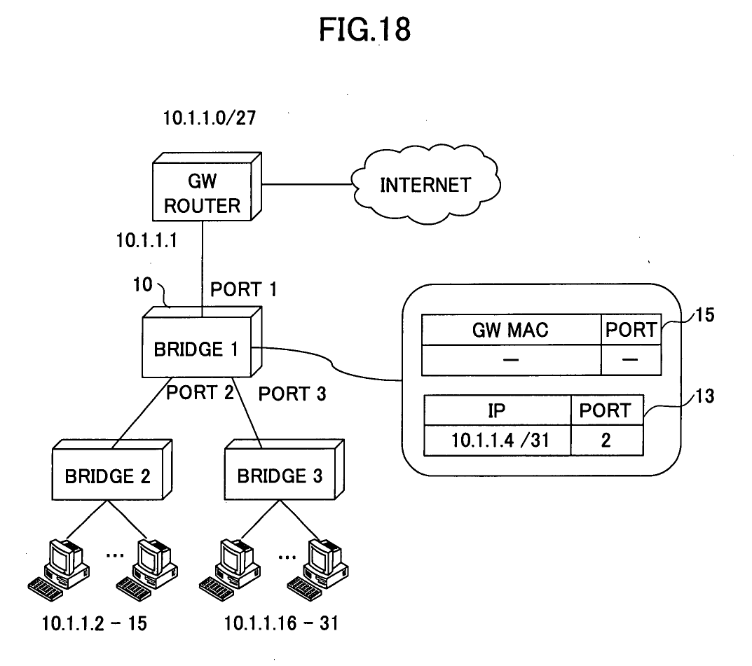

As a result of IP SA learning, two addresses, “10.1.1.4” and “10.1.1.5” are learned. Since-these addresses are completely identical each other except for the last (lower) 1 bit, the address can be degenerated to the address group of “10.1.1.4/31” in steps S9 and S10 of FIG. 13 (see FIG. 18).

Next, it is assumed that time passes after this and the bridge 1 relays a large number of the packets so that the address learning has progressed.

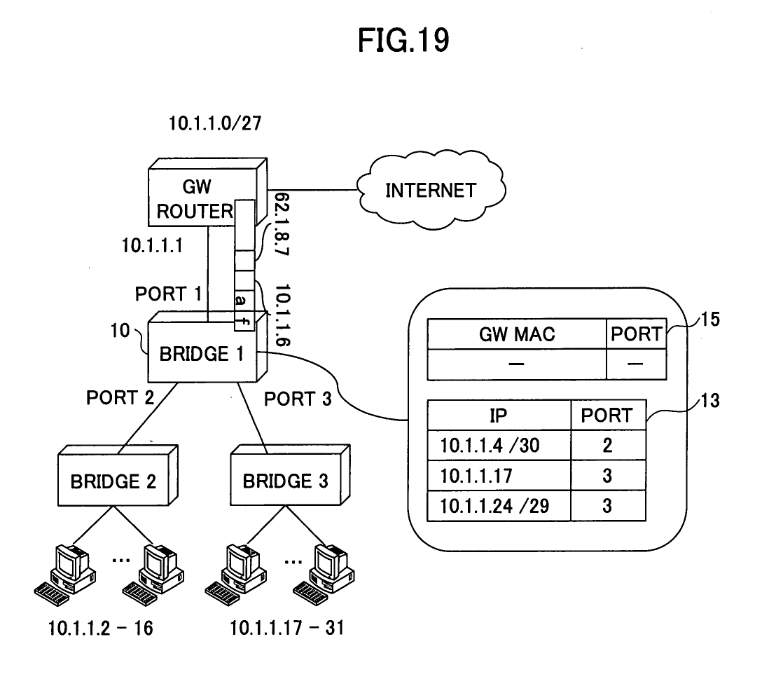

As shown in FIG. 19, if traffic arrives from outside of the domain via the gateway (GW) router, this packet is completely different from the addresses that the class B network has learned. In this case, the IP SA and the MAC SA are stored in the temporary storage area in steps S4, S6, and S7 of FIG. 13.

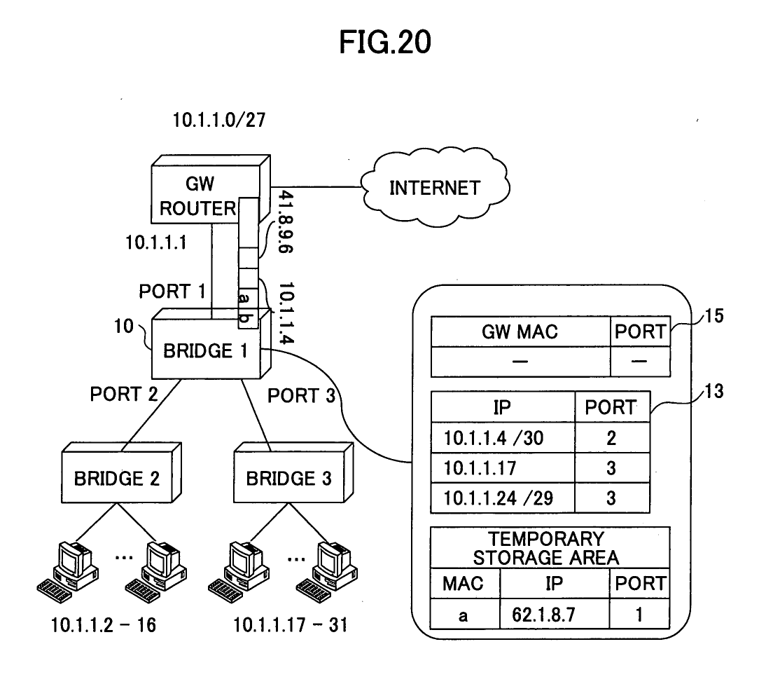

In addition, as shown in FIG. 20, if a new packet arrives via the gateway (GW) router, the IP SA of this packet is different from the IP SA stored in the temporary storage area and the MAC SA of this packet is the same as the MAC SA stored in the temporary storage area (YES in step S6).

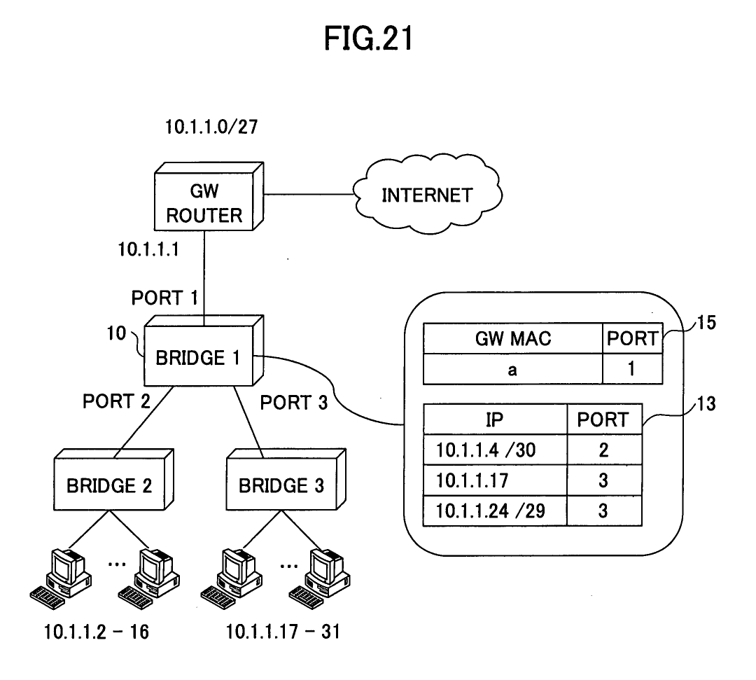

Therefore, as shown in FIG. 21, this MAC SA is determined as one received via the gateway router. Accordingly, stored information in the temporary storage area is deleted and information of the MAC SA is stored as an entry in the gateway router MAC address table in step S8.

Next, a process for degeneracy of the address of the embodiment of the present invention is discussed.

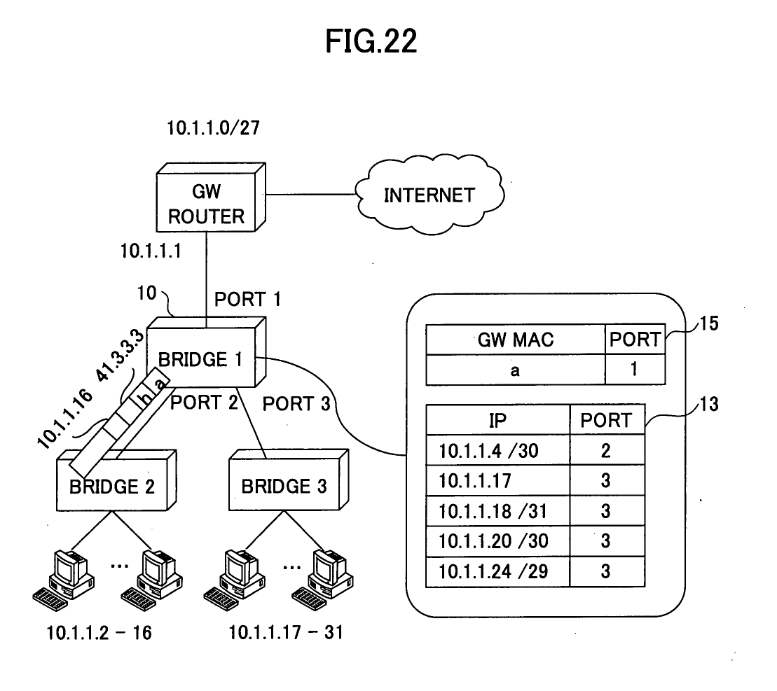

FIG. 22 shows that learning has further progressed from that shown in FIG. 21 so that address learning with respect to all addresses under the port 3 of the bridge 1 is completed.

Here, as shown in FIG. 22, it is assumed that the packet having the IP SA “10.1.1.16” arrives at the port 2. By learning this packet, all of packets of the address group “10.1.1.16/28” are learned at either port 2 or port 3 of the bridge 1. The port 2 is “10.1.1.2-16” and the port 3 is “10.1.1.17-31”.

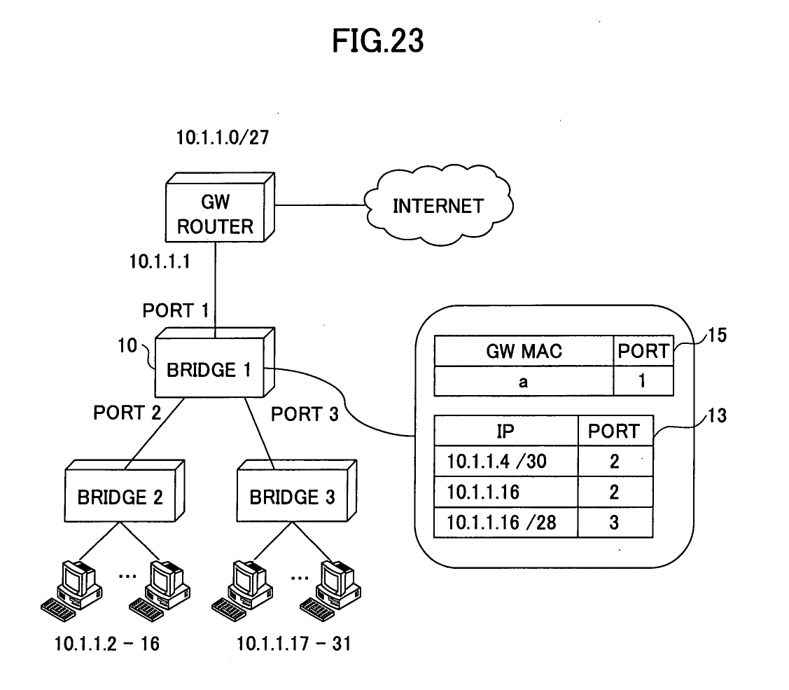

Therefore, if “a structure where degeneracy of the addresses is implemented, and a structure where degeneracy of addresses is implemented when all of them are not learned at the same port but a constant condition is satisfied” is applied, address learning by the IP address regarding “10.1.1.16” is implemented in the normal way so that the addresses are generated to “10.1.1.16/28” regarding the entries of the port 3. As a result of this, the address learning table 13 has the contents shown in FIG. 23.

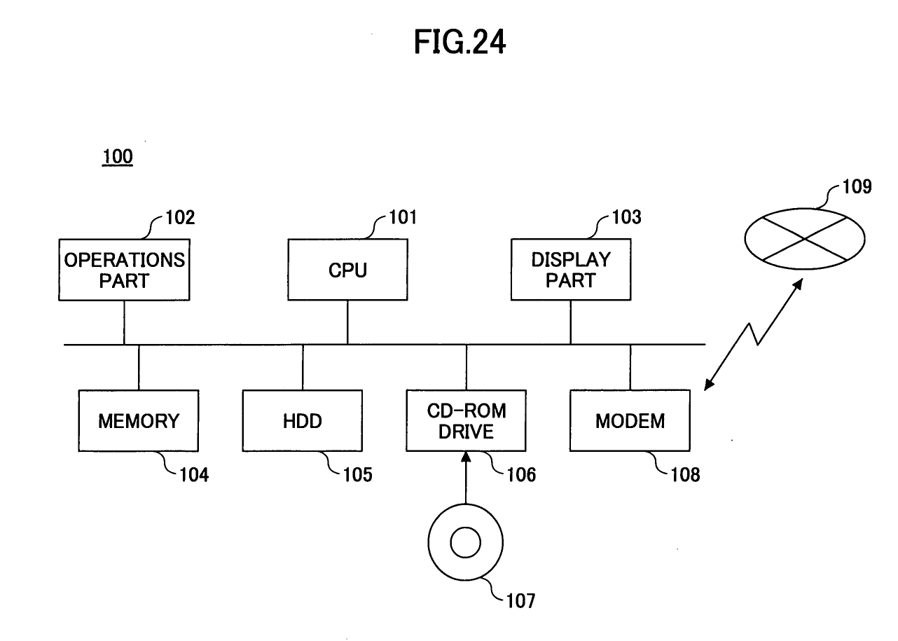

FIG. 24 is a block diagram for explaining an example where functions of the packet sending and receiving part 11, the packet processing part 12, the IP address table 13, the subnet storage part 14, the MAC address storage part 15, the IP address processing part 16 and the IP MAC address processing part 17 in the bridge 10 are realized by a computer 100.

As shown in FIG. 24, the computer 100 includes a CPU 101, an operations part 102, a display part 103, a memory 104, a hard disk device 105, a CD-ROM drive, and a modem 108. The CPU 101 implements a program. By the operations part 102 such as a keyboard and mouse, the user can input contents of operation and data. The display part 103, such as a CRT or liquid crystal display, displays process progress or process results by the CPU 101 to the user. The memory 104, such as ROM or RAM, stores data or the program implemented by the CPU 101 and is used as an operations area. The hard disk device 105 stores the program, data, or the like. The CD-ROM drive 106 loads the data or the program from outside via a CD-ROM 107. The modem 108 downloads a program from an outside server via a communication network 109 such as the Internet or a LAN and sends and receives the IP packet.

The CPU 101, memory 104 and modem 108 correspond to the packet sending and receiving part 11, packet processing part 12, the IP address processing part 16, and the IP MAC address processing part 17. The hard disk device 105 corresponds to the IP address table 13, the subnet storage part 14, and the MAC address storage part 15.

The computer 100 loads or downloads a program via the CD-ROM 107 or the communication network 109. The program is formed by commands for making the CPU 101 implement the address learning operation and the packet forwarding operation. This program is installed in the hard disk device 105 and loaded in the memory 104 so as to be implemented by the CPU 101. As a result of this, the address learning operation and the packet forwarding operation are implemented by the computer 100.

The present invention is not limited to these embodiments, but variations and modifications may be made without departing from the scope of the present invention.

This patent application is based on Japanese Priority Patent Application No. 2006-178475 filed on Jun. 28, 2006, the entire contents of which are hereby incorporated by reference.

What is claimed is:

1. A communication device configured to control destination of a received packet by implementing address learning, comprising:
an address learning part configured to implement the address learning by using an IP address of the received packet.

2. The communication device as claimed in claim 1, further comprising:
a subnet information obtaining part configured to obtain subnet information;
wherein the address learning part implements the address learning by using a host address in the IP address in a case where the subnet information can be obtained by the subnet information obtaining part.

3. The communication device as claimed in claim 1,
wherein the address learning part implements the address learning by using VLAN information.

4. The communication device as claimed in claim 1, further comprising:
an IP address learning suitability determining part configured to determine suitability of implement of the address learning by using the IP address;
wherein the address learning part does not implement address learning using a MAC address of the received packet in a case where the IP address learning suitability determining part determines that the address learning using the IP address is unsuitable.

5. The communication device as claimed in claim 4,
wherein, in the case where the IP address learning suitability determining part determines that the address learning using the IP address is unsuitable, the address learning part implements the address learning by using a MAC address of the received packet.

6. The communication device as claimed in claim 4, further comprising:
a subnet information obtaining part configured to obtain subnet information;
wherein the IP address learning suitability determining part determines that address learning using an IP address not belonging to a subnet obtained by the subnet information is unsuitable in a case where the subnet information obtaining part can be obtained by the subnet information obtaining part.

7. The communication device as claimed in claim 4, further comprising:
a subnet estimating part configured to estimate a subnet based on result of address learning using the IP address by the address learning part;
wherein the IP address learning suitability determining part determines that the address learning using an IP address not belonging to the subnet estimated by the subnet estimating part is unsuitable.

8. The communication device as claimed in claim 4,
wherein the IP address learning suitability determining part compares the MAC addresses and the IP addresses between the received packets, and determines that the IP address of one of the received packets is unsuitable as for the address learning if the one of the received packets has the same sender MAC address and a different sender IP address.

9. The communication device as claimed in claim 6,
wherein, in the case where the IP address learning suitability determining part determines that the address learning using the IP address is unsuitable, a port where a corresponding received packet arrives is set to be a default port, and
a packet forwarding part sends a received packet having an IP address as a destination IP address, which IP address is determined to be unsuitable for the address learning, to the default port.

10. The communication device as claimed in claim 1, further comprising:
an address degenerating part configured to implement address degeneracy of the IP address obtained by the address learning.

11. The communication device as claimed in claim 10,
wherein the address degenerating part implements address degeneracy of an IP address of a packet received at the same port.

12. The communication device as claimed in claim 1,
wherein the address learning part does not implement the address leaning in a case where the received packet does not have an IP address.

13. The communication device as claimed in claim 1,
wherein the address learning part implements the address learning by using a MAC address held by the received packet in a case where the received packet does not have an IP address.

14. An address learning method applied to a communication device configured to control a destination of a received packet by implementing address learning, the address learning method comprising:
a step of implementing the address learning by using an IP address of the received packet.

15. The address learning method as claimed in claim 14, further comprising:
an IP address learning suitability determining step of determining suitability of implementing the address learning by using the IP address;
wherein the address learning step does not implement address learning using a MAC address of the received packet in a case where it is determined in the IP address learning suitability determining step that the address learning using the IP address is unsuitable.

16. The address learning method as claimed in claim 15,
wherein, in the case where it is determined in the IP address learning suitability determining step that the address learning using the IP address is unsuitable, the address learning is implemented by using a MAC address of the received packet in the address learning step.

17. The address learning method as claimed in claim 15,
further comprising:
a subnet information obtaining step of obtaining subnet information;
wherein it is determined in the IP address learning suitability determining step that address learning using an IP address not belonging to a subnet obtained by the subnet information is unsuitable in a case where the subnet information can be obtained in the subnet information obtaining step.

18. The address learning method as claimed in claim 15, further comprising:
a subnet estimating step of estimating a subnet based on a result of the address learning using the IP address in the address learning step;
wherein it is determined in the IP address learning suitability determining step that the address learning using an IP address not belonging to the subnet estimated in the subnet estimating step is unsuitable.

19. The address learning method as claimed in claim 15,
wherein the MAC addresses and the IP addresses between the received packets are compared in the IP address learning suitability determining step, and
it is determined that the IP address of one of the received packets is unsuitable for the address learning if the one of the received packets has the same sender MAC address and a different sender IP address.

20. An address learning program for making the computer implement address learning in a communication device configured to control a destination of a received packet by implementing the address learning, the address learning program comprising:
a command for making the computer implement a step for implementing the address learning by using an IP address of the received packet.
